(19) United States
(12) Patent Application Publication
(10) Pub. No.: US 2025/0327477 A1
(43) Pub. Date: Oct. 23, 2025

(54) SPRING CLIPS TO RETAIN NUTS IN TIGHT MACHINE ACCESS AREAS

(71) Applicant: The Boeing Company, Arlington, VA (US)

(72) Inventor: Andrew Thomas Wendel, St. Louis, MO (US)

(21) Appl. No.: 18/640,408

(22) Filed: Apr. 19, 2024

(51) Int. Cl. F16B 37/04

(52) U.S. Cl. CPC F16B 37/044

(57) ABSTRACT

Spring clips to retain nuts in tight machine access areas are disclosed. An example spring clip includes a base plate having a first hole and a second hole disposed therein. The first hole is to permit passage of a bolt. The second hole is to secure a retainer to the base plate. The retainer is to hold a nut for the bolt in alignment with the first hole regardless of a presence of the bolt. The spring clip further includes an arm extending from the base plate. The arm includes a first portion and a second portion. The first portion of the arm extends in a first direction transverse to the base plate. The second portion of the arm extends in a second direction transverse to the first portion of the arm so as to overlap the base plate.

### FIELD OF THE DISCLOSURE

This disclosure relates generally to fastener assemblies and, more particularly, to spring clips to retain nuts in tight machine access areas.

### BACKGROUND

Bolts with associated nuts are used in many different contexts to secure different components together. In some situations, such as in a compact area where there is tight machine access, it can be difficult to position and hold a nut in place while a bolt is being inserted therein and/or removed from the nut (e.g., to disassemble the relevant components and/or replace the bolt).

### SUMMARY

An example spring clip includes a base plate having a first hole and a second hole disposed therein, the first hole to permit passage of a bolt, the second hole to secure a retainer to the base plate, the retainer to hold a nut for the bolt in alignment with the first hole regardless of a presence of the bolt, and an arm extending from the base plate, the arm including a first portion and a second portion, the first portion of the arm extending in a first direction transverse to the base plate, the second portion of the arm extending in a second direction transverse to the first portion of the arm so as to overlap the base plate.

An example unitary C-shaped clip made of sheet metal includes a first segment of the sheet metal including a first opening for passage of a bolt, a second segment of the sheet metal including a second opening, the second opening to increase a flexibility of the second segment relative to the first segment, and a third segment of the sheet metal including a third opening, the third opening to increase a flexibility of the third segment relative to the first segment, the second and third segments defining opposing ends of the C-shaped clip with the first segment disposed therebetween.

An example apparatus includes a spring clip including a hole in a central portion of the spring clip, the hole dimensioned to permit a bolt to pass through, the spring clip including first and second arms on opposing sides of the central portion, the first and second arms bent relative to the central portion so that the first and second arms extend towards one another in an area above the hole, and a nut to be fastened to the spring clip adjacent to and in alignment with the hole when the bolt is not extending through the hole.

### BRIEF DESCRIPTION OF THE DRAWINGS

FIG. 1 illustrates an example component with openings containing nut retaining assemblies constructed in accordance with teachings disclosed herein.

FIG. 2 is an exploded view of the component and one of the example nut retaining assemblies of FIG. 1.

FIG. 3 is an enlarged view of one of the example nut retaining assemblies of FIGS. 1 and 2.

FIG. 4 is an enlarged isometric view of the example spring clip of one of the example nut retaining assemblies of FIGS. 1-3.

FIG. 5 is an enlarged front view of the example spring clip of FIG. 4.

FIG. 6 is a cross-sectional view of the example component and nut retaining assemblies of FIG. 1

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

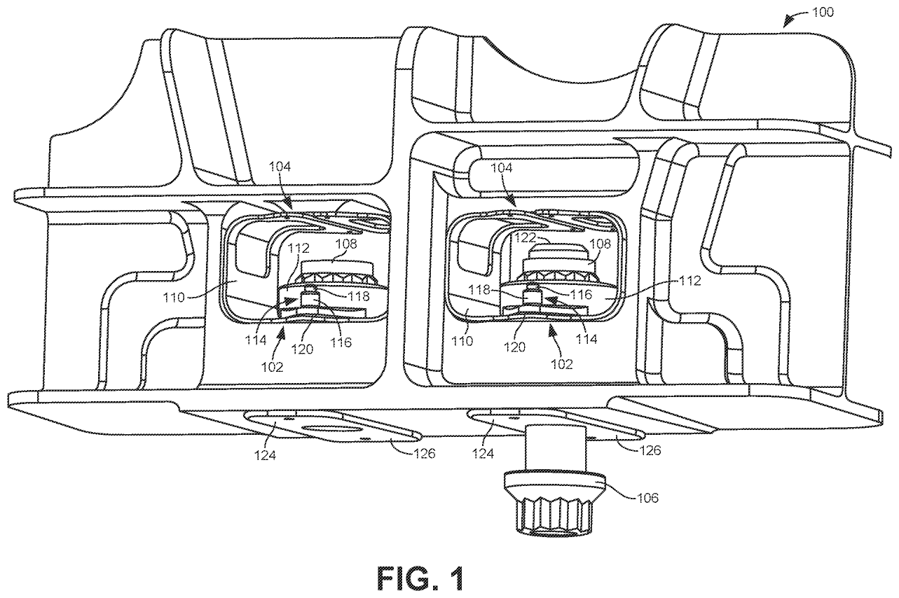

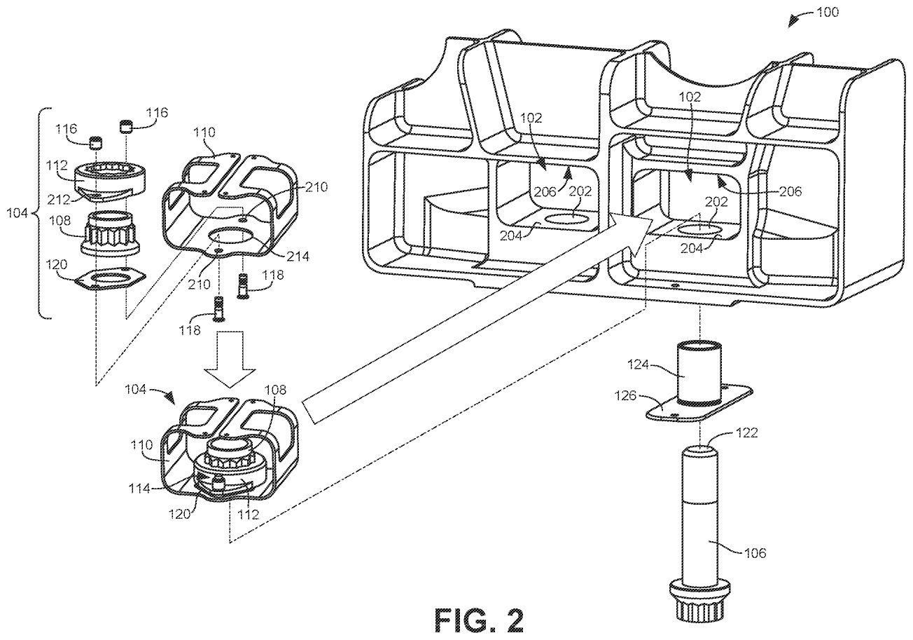

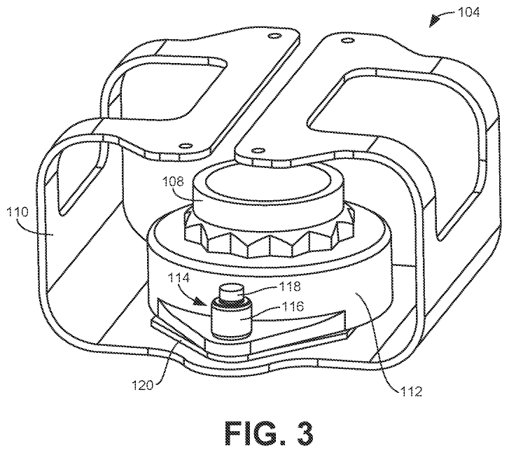

FIG. 1 illustrates an example component 100 with openings 102 (shown more clearly in FIG. 2) within which are disposed example nut retaining assemblies 104 constructed in accordance with teachings disclosed herein. FIG. 2 is an exploded view of the component 100 and one of the example nut retaining assemblies 104 of FIG. 1. FIG. 3 is an enlarged view of one of the example nut retaining assemblies 104 of FIGS. 1 and 2. The design, shape, and/or purpose of the component 100 is not relevant to this disclosure other than to illustrate that the openings 102 define constrained spaces resulting in tight machine access areas in which a threaded fastener or bolt 106 is to be fastened into a nut 108 disposed within the openings 102. More particularly, as shown in FIG. 2, each opening 102 includes a hole 202 (e.g., a bore) in a first surface 204 (e.g., sidewall) of the opening through which the bolt 106 is to pass to reach into the opening 102 where the bolt 106 may engage with the nut 108. However, in this example, each opening 102 includes a second surface 206 that is opposite to (e.g., faces towards) the first surface 204 and is aligned with the hole 202. Due to the proximity of the second surface 206 to the first surface 204 and due to the fact that the second surface 206 is aligned with the hole 202, the second surface 206 obstructs clear access to the hole 202 from a direction axial aligned with the hole 202. Small spaces, such as the openings 102, into which the nut 108 is to be placed for fastening onto the bolt 106 can present challenges for assembly and disassembly of the bolt 106 and related parts of the component 100. Specifically, the confined space within the openings 102 can make it difficult to position the nut 108 when the bolt 106 is being threaded into the nut 108 and/or to retain the nut 108 in place after removal and/or during replacement of the bolt 106. One solution is to use a retainer that holds the nut 108 in place while the bolt 106 is being threaded into or removed from the nut 108. Often such retainers are affixed to the associated component 100 using separate fasteners (e.g., screws, bolts, rivets, etc.) extending through corresponding holes in the component 100. However, in tight machine access areas, as shown in the illustrated example, it may not be possible or practical to produce such holes. Other solutions to secure the nut 108 in place involve complex designs and/or parts that can require additional material that can have significant costs and/or add significant weight to the overall assembly. The above challenges are mitigated through the use of the relatively light weight nut retaining assembly 104 shown in FIGS. 1 and 2 and further detailed in the enlarged view of FIG. 3.

As shown in the illustrated examples of FIGS. 1-3, the nut retaining assemblies 104 include a spring clip 110 to which the nut 108 is fastened or held by a nut retainer 112 (or simply retainer for short). In this example, the nut retainer 112 is secured to the spring clip 110 by a pair of lock bolts 114. The lock bolts 114 include a collar 116 attached to the end of a pin 118 that extends through holes 210 (e.g., openings) in the spring clip 110 and corresponding holes 212 (e.g., openings) in the retainer 112 as shown in FIG. 2. In some examples, the holes 210 in the spring clip 110 are countersunk holes so that the heads of the lock bolts 114 fit inside and flush against the outer surface (e.g., bottom surface in the illustrated examples) of the spring clip 110. In some examples, a spacer 120 is positioned between the spring clip 110 and the retainer 112 with the lock bolts 114 extending therethrough. In other examples, the spacer 120 is omitted. While two lock bolts 114 are shown, in other examples any suitable number (e.g., 1, 2, 3, 4, etc.) of lock bolts 114 may be used to secure the retainer 112 to the spring clip 110. In some examples, different types of threaded fasteners (other than lock bolts) may additionally or alternatively be used to secure the retainer 112 to the spring clip 110. In some examples, the retainer 112 can additionally or alternatively be attached to the spring clip 110 in any other suitable manner such as with welding (e.g., a tack weld), with an interference fit (e.g., via staking), with an adhesive, etc.

As shown in the illustrated examples, the retainer 112 fits over and around the nut 108. As a result, by attaching the retainer 112 to the spring clip 110, the nut 108 is held in position or retained in place over a bolt hole 214 (e.g., an opening) in the spring clip 110. In this example, the bolt hole 214 is positioned on the spring clip 110 to align with the hole 202 in the component 100 when the nut retaining assembly 104 is disposed in the opening 102 of the component 100. Further, in this example, the bolt hole 214 in the spring clip 110 is dimensioned to enable an end 122 of the bolt 106 to pass therethrough to be threaded into the nut 108 that is held in place on the spring clip 110 by the retainer 112 that is attached thereto. In some examples, the retainer 112 is omitted and the nut 108 is directly attached to the spring clip 110. For instance, in some examples, the nut 108 includes a flange with holes through which the lock bolts 114 can extend. That is, in some examples, the structure and/or functionality of the retainer 112 is incorporated into and/or made an integral part of the nut 108 to enable the nut 108 to be secured to the spring clip 110. Additionally or alternatively, in some examples, the nut 108 can be directly attached to the spring clip 110 in any other suitable manner (e.g., welding, staking, adhesive, etc.).

In some examples, a bushing 124 lines the wall of the hole 202 that extends through the component 100 to surround the bolt 106 when installed within the hole 202. In some examples, the bushing 124 is press fit into the hole 202. Additionally or alternatively, in some examples, the bushing 124 includes an end plate (e.g., a flange) 126 that enables the bushing 124 to be secured to the component 100. In some examples, the bushing 124 is omitted.

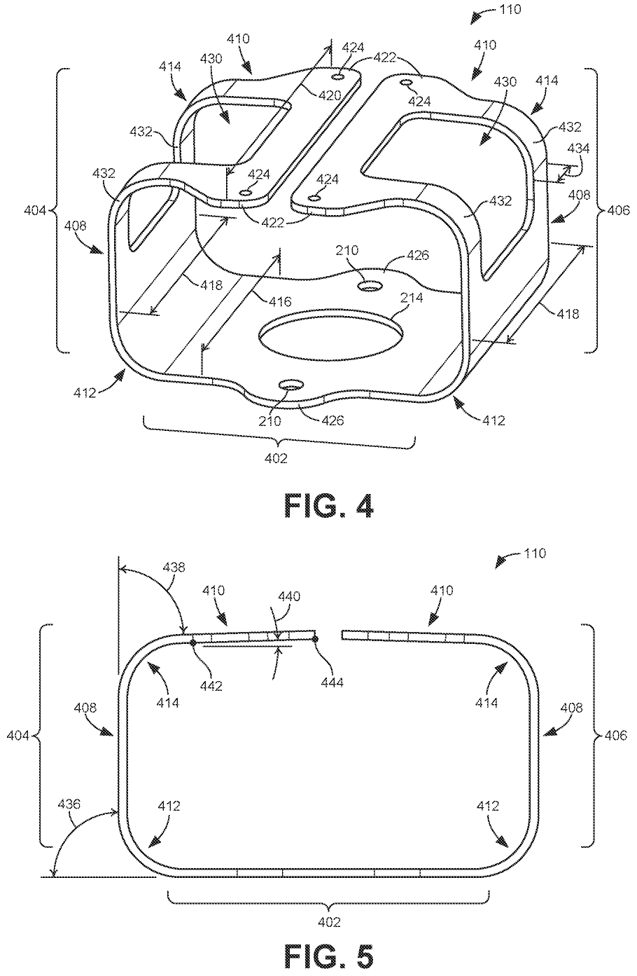

In some examples, the nut retaining assembly 104 (including the spring clip 110 and the nut 108 and retainer 112 coupled thereto) can be manually inserted into and removed from the openings 102 in the component 100 as an assembly. Further, in some examples, the spring clip 110 is designed to be held in position within the opening 102 based on the flexible nature of the spring clip 110. That is, as discussed more fully in connection with FIGS. 4-6, the spring clip 110 is designed with flexible arms that can be compressed or deflected when the spring clip 110 is inserted into the opening 102 of the component 100. Once inserted, the compressed or deflected arms of the spring clip 110 spring back to a non-compressed state to press against the sidewalls or surfaces of the opening 102. The spring force of the spring clip 110 pressing against the sidewalls of the opening 102 creates friction that helps maintain the spring clip 110 in place. As a result, the nut 108, which is secured relative to the spring clip 110 by the retainer 112, is also held in place. In this manner, it is possible to maintain the position of the nut 108 relative to the hole 202 in the component 100 regardless of whether a bolt 106 is extending through the hole 202 and threaded into the nut 108.

Thus, as shown in FIG. 1, both openings 102 include the nut retaining assembly 104 disposed therein. The nut retaining assembly 104 on the right in FIG. 1 is secured in place by the bolt 106 that has been threaded all the way through the nut 108 as indicated by the end 122 of the bolt 106 protruding out through the nut 108. By contrast, there is no bolt coupled to the nut retaining assembly 104 on the left in FIG. 1. However, the nut retaining assembly 104 on the left is nevertheless held in position by frictional forces created between the flexible (e.g., compressible) nature of the spring clip 110 and the walls of the associated opening 102.

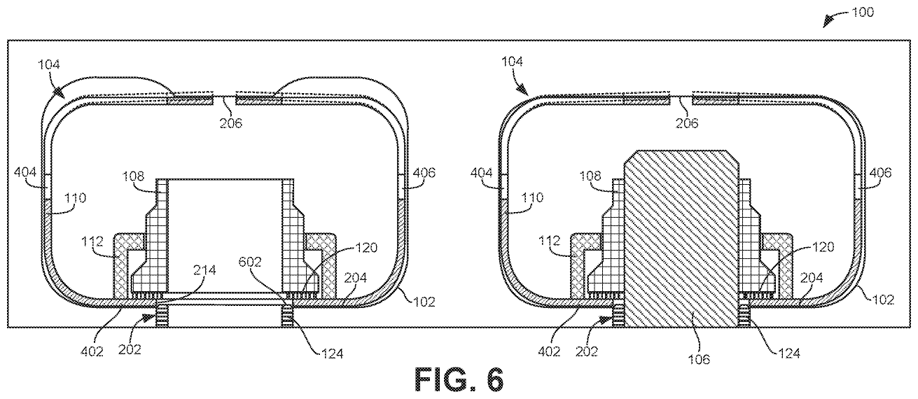

FIG. 4 is an isometric view of the example spring clip 110 of the example nut retaining assembly 104 of FIGS. 1-3. FIG. 5 is a front view of the example spring clip of FIG. 4. In the illustrated example, the spring clip 110 is fabricated from a single piece of sheet metal that has been bent into a C-shape. This is, in some examples, the spring clip is a unitary C-shaped clip. More particularly, the C-shaped spring clip 110 is defined by a base plate 402 (e.g., a central portion, a first segment of the sheet metal) disposed between opposing first and second arms 404, 406 (e.g., second and third segments of the sheet metal) on either side of the base plate 402. In some examples, when the spring clip 110 is fabricated from a single sheet of metal, the arms 404, 406 are integral extensions of the base plate 402. In some examples, the metal is spring steel.

In this example, the first and second arms 404, 406 have the same shape. Accordingly, the same reference numbers are used to identify the common features between the arms 404, 406 but only the first arm 404 is described in detail. In other examples, each arm 404, 406 may have a different shape. As shown in the illustrated example, the first arm 404 includes a first portion 408 that is adjacent or proximal to the base plate 402 and a second portion 410 that is distal to the base plate 402. That is, the first portion 408 of the first arm 404 is between the base plate 402 and the second portion 410 of the first arm 404.

As shown in the illustrated example, the location defining the intersection between the first arm 404 and the base plate 402 is demarcated by a first bend 412 in the sheet metal between the base plate 402 and the first arm 404 (e.g., the first portion 408 of the first arm) such that the first portion 408 of the first arm 404 extends in a direction that is transverse to the base plate 402. Further, the location defining the intersection between the first and second portions 408, 410 of the first arm 404 is demarcated by a second bend 414 in the sheet metal between the two portions such that the second portion 410 extends in a direction that is transverse to the first portion 408. In this example, the different bends 412, 414 are parallel to one another (e.g., the bend axes are parallel) and result in the second portions 410 of the two the arms 404, 406 extending towards one another and towards an area above the bolt hole 214 (e.g., so as to overlap the base plate 402).

In some examples, the base plate 402 has a first width 416 extending between opposite edges of the base plate 402. In some examples, the arms 404, 406 have a second width 418 that corresponds to the first width 416 of the base plate 402. However, in some examples, an end of the second portion 410 of the first arm 404 (that is distal to the first portion 408 of the first arm 404) has a third width 420 that is greater than the second width 418. In some such examples, the larger third width 420 is associated with first tabs 422 that protrude outward from a side (e.g., edge) of the arms (e.g., the side of the distal end of the second portion of the first arm 404). In some examples, the first tabs 422 are dimensioned to protrude out from the openings 102 of the component 100 (as shown in FIG. 1) to enable a person to press down on the tabs 422 to overcome the spring force in the arms 404, 406 and remove the spring clip 110 from the opening 102. In some examples, the first tabs 422 include holes 424 (e.g., openings) in the first tabs 422 that are exposed when the nut retaining assembly 104 is positioned within the opening 102 of the component 100. In such examples, the holes 424 enable safety wire to be fed therethrough and tied or otherwise attached to an adjacent structure (e.g., a different part of the component 100). The safety wire through the holes 424 provides an additional means for retaining the nut retaining assembly 104 within the opening 102 beyond the reactive spring force created from the flexible nature of the spring clip 110 as noted above and detailed further below. In some examples, the safety wire and/or the holes 424 in the tabs 422 may be omitted. In some examples, the first tabs 422 may be omitted.

In some examples, the base plate 402 includes second tabs 426 protruding outward from opposing edges of the base plate 402. In this example, the holes 210 for the lock bolts 114 are positioned within the second tabs 426. In other examples, the holes 210 can be positioned at any other suitable location on the base plate 402. Accordingly, in some examples, the second tabs 426 may be omitted. However, in some examples, even if the holes 210 are omitted, the second tabs 426 are nevertheless retained to serve as finger grips that facilitate a user installing and/or removing the nut retaining assembly 104 from an opening 102 in the component 100. Further, in examples where the retainer 112 and/or the nut 108 is coupled to the spring clip 110 using a different mechanism other than the lock bolts (e.g., welding, staking, adhesive etc.), the holes 210 may also be omitted. In this example, the holes 210 are positioned on either side of the bolt hole 214 in the base plate 402. As discussed above, the bolt hole 214 is dimensioned to permit the bolt 106 to pass through. Thus, in some examples, the bolt hole 214 is positioned on the base plate 402 to be aligned with the hole 202 in the component 100 (shown in FIG. 2) when the nut retaining assembly 104 is installed within one of the openings 102 in the component 100. Further, in some examples, the smaller holes 210 (for the lock bolts 114) are positioned relative to the (larger) bolt hole 214 so that when the retainer 112 is attached to the spring clip 110, the nut 108 is held in alignment with the bolt hole 214 to receive and engage with a bolt 106 when the bolt 106 is inserted. That is, the holes 210, 214 are positioned so that the retainer 112 holds the nut 108 in alignment with the bolt hole 214 regardless of the presence of the bolt 106.

In some examples, the first arm 404 includes an opening or cutout 430 to reduce the amount of material along the length of the first arm 404, thereby reducing the stiffness and increasing the flexibility of the first arm 404. That is, in some examples, the cutout 430 results in the first arm 404 being more flexible than the base plate 402. In some examples, the cutout 430 extends across the second bend 414. That is, the cutout 430 extends along part of both the first and second portions 408, 410 of the first arm 404. In the illustrated example of FIG. 4, the cutout 430 is centrally located between opposing edges of the first arm 404 such that the remaining material of the first arm 404 is defined by two narrow necks or stems 432 on either side of the cutout 430. As shown, the stems 432 have a fourth width 434 that is less than the first, second, and third widths 416, 418, 420. The fourth width 434 can be any suitable width to provide a suitable amount of flexibility or deflection in the first arm 404 to enable a human to manually compress the spring clip 110 and install the nut retaining assembly 104 into an opening without the use of tools. In some examples, the first arm 404 can include a different number of stems 432 and a different associated number of cutouts 430 disposed therebetween from what is shown in FIG. 4. In some examples, the first arm 404 includes only a single stem 432 with the cutout(s) 430 positioned along the edges of the first arm 404 on either side of the single stem 432.

In some examples, the first bend 412 (between the first portion 408 of the first arm 404 and the base plate 402) is defined by a first angle 436 and the second bend 414 (between the first and second portions 408, 410 of the first arm 404) is defined by a second angle 438. In this example, the second angle 438 is less than the first angle 436. More particularly, in some examples, the first angle 436 is 90 degrees and the second angle 438 is 88.5 degrees. In other examples, the angles 436, 438 may be at other suitable values. Regardless of the particular values of the angles 436, 438, in some examples, the two angles sum to slightly less than 180 degrees so that the second portion 410 of the first arm 404 extends slightly upward at a third angle 440 relative to the base plate 402. In some examples, the third angle 440 is between 0.5 degrees and 3 degrees (e.g., 0.5 degrees, 1 degree, 1.5 degrees, 2 degrees, 2.5 degrees, 3 degrees, etc.). In some examples, the third angle 440 can be less than 0.5 degrees or more than 3 degrees. Based on the slight angle of the second portion 410 of the first arm 404 relative to the base plate 402, due to the angles 436, 438 of the first and second bends 412, 414, a first point 442 on the second portion 410 of the first arm 404 is closer to the base plate 402 than a second point 444 on the second portion 410 of the first arm 404 is to the base plate 402, where the first point 442 is closer to the first portion 408 of the first arm 404 than the second point 444 is to the first portion 408. In some examples, the first arm 404 can include multiple bends (e.g., more than one) to achieve any other suitable shape and/or suitable flexibility.

FIG. 6 is a cross-sectional view of the example component 100 and nut retaining assemblies 104 of FIG. 1. As shown in the illustrated example, the nut retaining assembly 104 on the right includes the bolt 106 threaded through the nut 108. By contrast, there is no bolt in the nut retaining assembly 104 on the left in FIG. 6. Regardless of whether a bolt 106 is present, the nut retaining assemblies 104 are held in place within the openings 102 of the component 100 by the spring clip 110. More particularly, as shown in the illustrated example, the free ends (e.g., distal ends) of the arms 404, 406 are deflected or compressed toward the base plate 402 relative to the non-deflected state (represented in dashed lines) to fit within the openings 102. This creates a spring force in the spring clip 110 that urges the arms 404, 406 against the top surface 206 of the opening and a corresponding force against the bottom surface 204 of the opening 102. The resulting spring force produces friction to maintain the spring clip 110 in place within the opening 102. Furthermore, because the retainer 112 is positioned over and/or around the nut 108 and secured to the spring clip 110, the nut 108 is held in position relative to the spring clip 110. As a result, the nut 108 is also held in alignment with the hole 202 for the bolt 106 in the component 100. In some examples, to facilitate indexing or alignment of the nut retaining assembly 104 (and, thus, the nut 108) relative to hole 202, an end 602 of the bushing 124 extends slightly beyond the bottom surface 204 of the opening 102 of the component 100 and into the bolt hole 214 of the spring clip 110. The bushing 124 thus provides an additional means for retaining the nut retaining assembly 104 within the opening 102 beyond the reactive spring force created from the flexible nature of the spring clip 110 as noted above. In some examples, the bushing 124 protrudes no more than the thickness of the metal sheet used for the spring clip 110. In some examples, the thickness of the metal sheet is 0.040 inches, but greater and smaller thickness could also be used. In some examples, the bushing 124 does not extend beyond the surface 204 of the opening 102 and, thus, remains spaced apart from the spring clip 110.

In some examples, the general shape of the spring clip 110 corresponds to the shape of the opening 102 into which the nut retaining assembly 104 is inserted, as in the case of the spring clip 110 shown on the right in FIG. 6. However, in other examples, the shape of the spring clip 110 may differ from the shape of the opening 102, as in the case of the spring clip 110 shown on the lift in FIG. 6.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example apparatus have been disclosed that enable the securing of a nut in a fixed relationship relative to a hole through which a bolt is to extend to engage with and be threaded into the nut regardless of whether the bolt is present. This can be done in relatively tight machine access areas through the use of a spring clip that supports the nut. More particularly, in some examples, the spring clip is manually compressible to fit within the small opening associated with the tight machine access area to create spring forces that press against the walls of the opening to hold the spring clip and, thus, the associated nut, in place. Examples disclosed herein weigh less, cost less, and/or are less complex than other known solutions to retain a nut in a confined space in the absence of a bolt.

Further examples and combinations thereof include the following:

Example 1 includes a spring clip comprising a base plate having a first hole and a second hole disposed therein, the first hole to permit passage of a bolt, the second hole to secure a retainer to the base plate, the retainer to hold a nut for the bolt in alignment with the first hole regardless of a presence of the bolt, and an arm extending from the base plate, the arm including a first portion and a second portion, the first portion of the arm extending in a first direction transverse to the base plate, the second portion of the arm extending in a second direction transverse to the first portion of the arm so as to overlap the base plate.

Example 2 includes the spring clip of example 1, wherein the first portion of the arm is an integral extension of the base plate, and the second portion of the arm is an integral extension of the first portion of the arm.

Example 3 includes the spring clip of any one of examples 1 or 2, wherein both the arm and the base plate are defined by a sheet of metal, the sheet of metal including a first bend at an intersection of the base plate and the first portion of the arm, the sheet of metal including a second bend at an intersection of the first portion of the arm and the second portion of the arm.

Example 4 includes the spring clip of example 3, wherein the first bend is defined by a first angle between the base plate and the first portion of the arm, and the second bend is defined by a second angle between the first portion of the arm and the second portion of the arm, the second angle less than the first angle.

Example 5 includes the spring clip of any one of examples 3 or 4, wherein the first and second bends are defined by corresponding first and second angles that result in a first point on the second portion of the arm being closer to the base plate than a second point on the second portion of the arm is to the base plate, the first point closer to the first portion of the arm than the second point is to the first portion of the arm.

Example 6 includes the spring clip of any one of examples 1-5, wherein the arm includes a stem connecting the first portion of the arm and the second portion of the arm, the stem narrower than a width of the base plate.

Example 7 includes the spring clip of example 6, wherein the stem is a first stem, and the arm includes a second stem, the first and second stems define opposite sides of a cutout in the arm.

Example 8 includes the spring clip of any one of examples 6 or 7, wherein at least a segment of the first portion of the arm has a first width, the first width corresponding to the width of the base plate.

Example 9 includes the spring clip of any one of examples 1-8, wherein the arm includes a cutout to increase a flexibility of the arm.

Example 10 includes the spring clip of any one of examples 1-9, wherein the arm is a first arm, the spring clip further including a second arm including a third portion and a fourth portion, the third portion extending in a third direction transverse to the base plate, the fourth portion extending in a fourth direction transverse to the third portion, the fourth portion of the second arm extending towards the second portion of the first arm, the second portion of the first arm extending towards the fourth portion of the second arm.

Example 11 includes the spring clip of any one of examples 1-10, wherein the base plate includes a tab protruding outward from an edge of the base plate, the second hole disposed in the tab.

Example 12 includes the spring clip of any one of examples 1-11, wherein the arm includes a tab protruding from a side of the arm, the tab including a third hole.

Example 13 includes a unitary C-shaped clip made of sheet metal comprising a first segment of the sheet metal including a first opening for passage of a bolt, a second segment of the sheet metal including a second opening, the second opening to increase a flexibility of the second segment relative to the first segment, and a third segment of the sheet metal including a third opening, the third opening to increase a flexibility of the third segment relative to the first segment, the second and third segments defining opposing ends of the C-shaped clip with the first segment disposed therebetween.

Example 14 includes the unitary C-shaped clip of example 13, wherein the second segment is coupled to the first segment at a first bend in the sheet metal, the second segment including a second bend parallel to the first bend, the first bend having a first angle, the second bend having a second angle, the first angle and the second angle summing to less than 180 degrees.

Example 15 includes the unitary C-shaped clip of example 14, wherein the second opening extends across the second bend.

Example 16 includes the unitary C-shaped clip of any one of examples 13-15, wherein the second segment has a first width at a first end distal to the first segment and a second width at a second end proximal to the first segment, the first width greater than the second width.

Example 17 includes the unitary C-shaped clip of any one of examples 13-16, wherein the first segment of the sheet metal includes fourth and fifth openings on opposite sides of the first opening.

Example 18 includes an apparatus comprising a spring clip including a hole in a central portion of the spring clip, the hole dimensioned to permit a bolt to pass through, the spring clip including first and second arms on opposing sides of the central portion, the first and second arms bent relative to the central portion so that the first and second arms extend towards one another in an area above the hole, and a nut to be fastened to the spring clip adjacent to and in alignment with the hole when the bolt is not extending through the hole.

Example 19 includes the apparatus of example 18, wherein the hole is a first hole, the apparatus further including a retainer to be secured to the spring clip via second and third holes in the spring clip, the first hole larger than the first hole and larger than the second hole, the first hole between the second and third holes, the nut to be fastened to the spring clip by the retainer.

Example 20 includes the apparatus of any one of examples 18 or 19, wherein the first and second arms include respective first and second cutouts to provide flexibility to the first and second arms.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A spring clip comprising:
a base plate having a first hole and a second hole disposed therein, the first hole to permit passage of a bolt, the second hole to secure a retainer to the base plate, the retainer to hold a nut for the bolt in alignment with the first hole regardless of a presence of the bolt; and
an arm extending from the base plate, the arm including a first portion and a second portion, the first portion of the arm extending in a first direction transverse to the base plate, the second portion of the arm extending in a second direction transverse to the first portion of the arm so as to overlap the base plate.

2. The spring clip of claim 1, wherein the first portion of the arm is an integral extension of the base plate, and the second portion of the arm is an integral extension of the first portion of the arm.

3. The spring clip of claim 1, wherein both the arm and the base plate are defined by a sheet of metal, the sheet of metal including a first bend at an intersection of the base plate and the first portion of the arm, the sheet of metal including a second bend at an intersection of the first portion of the arm and the second portion of the arm.

4. The spring clip of claim 3, wherein the first bend is defined by a first angle between the base plate and the first portion of the arm, and the second bend is defined by a second angle between the first portion of the arm and the second portion of the arm, the second angle less than the first angle.

5. The spring clip of claim 3, wherein the first and second bends are defined by corresponding first and second angles that result in a first point on the second portion of the arm being closer to the base plate than a second point on the second portion of the arm is to the base plate, the first point closer to the first portion of the arm than the second point is to the first portion of the arm.

6. The spring clip of claim 1, wherein the arm includes a stem connecting the first portion of the arm and the second portion of the arm, the stem narrower than a width of the base plate.

7. The spring clip of claim 6, wherein the stem is a first stem, and the arm includes a second stem, the first and second stems define opposite sides of a cutout in the arm.

8. The spring clip of claim 6, wherein at least a segment of the first portion of the arm has a first width, the first width corresponding to the width of the base plate.

9. The spring clip of claim 1, wherein the arm includes a cutout to increase a flexibility of the arm.

10. The spring clip of claim 1, wherein the arm is a first arm, the spring clip further including a second arm including a third portion and a fourth portion, the third portion extending in a third direction transverse to the base plate, the fourth portion extending in a fourth direction transverse to the third portion, the fourth portion of the second arm extending towards the second portion of the first arm, the second portion of the first arm extending towards the fourth portion of the second arm.

11. The spring clip of claim 1, wherein the base plate includes a tab protruding outward from an edge of the base plate, the second hole disposed in the tab.

12. The spring clip of claim 1, wherein the arm includes a tab protruding from a side of the arm, the tab including a third hole.

13. A unitary C-shaped clip made of sheet metal comprising:
a first segment of the sheet metal including a first opening for passage of a bolt;
a second segment of the sheet metal including a second opening, the second opening to increase a flexibility of the second segment relative to the first segment; and
a third segment of the sheet metal including a third opening, the third opening to increase a flexibility of the third segment relative to the first segment, the second and third segments defining opposing ends of the C-shaped clip with the first segment disposed therebetween.

14. The unitary C-shaped clip of claim 13, wherein the second segment is coupled to the first segment at a first bend in the sheet metal, the second segment including a second bend parallel to the first bend, the first bend having a first angle, the second bend having a second angle, the first angle and the second angle summing to less than 180 degrees.

15. The unitary C-shaped clip of claim 14, wherein the second opening extends across the second bend.

16. The unitary C-shaped clip of claim 13, wherein the second segment has a first width at a first end distal to the first segment and a second width at a second end proximal to the first segment, the first width greater than the second width.

17. The unitary C-shaped clip of claim 13, wherein the first segment of the sheet metal includes fourth and fifth openings on opposite sides of the first opening.

18. An apparatus comprising:
a spring clip including a hole in a central portion of the spring clip, the hole dimensioned to permit a bolt to pass through, the spring clip including first and second arms on opposing sides of the central portion, the first and second arms bent relative to the central portion so that the first and second arms extend towards one another in an area above the hole; and
a nut to be fastened to the spring clip adjacent to and in alignment with the hole when the bolt is not extending through the hole.

19. The apparatus of claim 18, wherein the hole is a first hole, the apparatus further including a retainer to be secured to the spring clip via second and third holes in the spring clip, the first hole larger than the second hole and larger than the third hole, the first hole between the second and third holes, the nut to be fastened to the spring clip by the retainer.

20. The apparatus of claim 18, wherein the first and second arms include respective first and second cutouts to provide flexibility to the first and second arms.
